(19) United States
(12) Patent Application Publication
(10) Pub. No.: US 2008/0153974 A1
(43) Pub. Date: Jun. 26, 2008

(54) Process for Preparing an Aqueous Addition-Polymer Dispersion

(75) Inventors: Wolfgang Gaschler, Ludwigshafen (DE); Thomas Danner, Erpolzheim (DE); Andreas Bauder, Mannheim (DE); Steffen Funkhauser, Viernheim (DE); Christoph Hamers, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/816,028

(22) PCT Filed: Feb. 23, 2006
(86) PCT No.: PCT/EP06/60239

§ 371 Date: Aug. 10, 2007

(30) Foreign Application Priority Data
Feb. 24, 2005 (DE) 10 2005 008 868.6

(51) Int. Cl. C08L 31/04; C08L 33/08; C08L 33/10; C08L 25/04; C08L 27/08; C08L 23/18; C08L 27/06

(52) U.S. Cl. 524/563; 524/543; 524/556; 524/577; 524/579; 524/568

(57) ABSTRACT

A process for preparing an aqueous polymer dispersion by free-radically initiated emulsion polymerization using an aqueous monomer miniemulsion which is obtained by passing an aqueous crude monomer emulsion through at least one microporous membrane having an average pore diameter≦1000 nm.

The present invention provides a process for preparing an aqueous polymer dispersion by free-radically initiated polymerization of at least one ethylenically unsaturated monomer in the presence of a dispersing assistant and also if appropriate of a low-water-solubility organic solvent in an aqueous medium, at least a portion of the ethylenically unsaturated monomer and if appropriate of the low-water-solubility organic solvent in the aqueous medium being present in the form of a disperse phase having an average droplet diameter≦1000 nm (miniemulsion), which comprises preparing the miniemulsion by first preparing a crude emulsion having an average droplet diameter≧2 μm, comprising at least portions of water, dispersing assistant, ethylenically unsaturated monomer, and, if appropriate, low-water-solubility organic solvent, and subsequently passing said crude emulsion through at least one microporous membrane having an average pore diameter≦1000 nm.

Processes for preparing aqueous polymer dispersions by free-radical polymerization of ethylenically unsaturated monomers which are present, together if appropriate with a solvent of low solubility in water (low-water-solubility solvent), in an aqueous medium in the form of a disperse phase having an average droplet size≦1000 nm (miniemulsion) are sufficiently well known to the skilled worker [in this regard see, for example, P. L. Tang, E. D. Sudol, C. A. Silebi, and M. S. El-Aasser in Journal of Applied Polymer Science, Vol. 43, pp. 1059 to 1066 (1991) or K. Landfester, Macromol. Rapid Commun. Vol 22, pp. 896 to 936 (2001)]. Common to these processes is that first, from the ethylenically unsaturated monomers, dispersing assistants, and water, and also, if appropriate, low-water-solubility organic solvent and further assistants, a crude monomer emulsion having an average droplet diameter≧2 μm is prepared by mixing, and in a subsequent process step is converted, with a high energy input, accomplished by means for example of high-speed rotary crown-gear dispersers, high-pressure homogenizers or ultrasound, into a monomer miniemulsion having an average droplet diameter≦1000 nm. Disadvantages of these known processes are the technically complicated preparation of the monomer miniemulsion in conjunction with a higher mechanical wear of the apparatus employed, and also the high energy consumption required for preparing the monomer miniemulsion.

It was an object of the present invention to provide a new process for preparing aqueous polymer dispersions, starting from aqueous crude emulsions of ethylenically unsaturated monomers.

Surprisingly the object has been achieved by means of the process defined at the outset.

Essential to the process is that the monomer miniemulsion is prepared by first preparing a crude emulsion having an average droplet diameter≧2 μm, comprising at least portions of water, dispersing assistant, ethylenically unsaturated monomer, and, if appropriate, low-water-solubility organic solvent in the form of a disperse phase. Frequently a crude emulsion is prepared which comprises the major amount of water and the total amounts of dispersing assistant, ethylenically unsaturated monomers, and, if appropriate, low-water-solubility organic solvent.

Suitable ethylenically unsaturated monomers for the free-radically initiated polymerization include, in particular, ethylenically unsaturated monomers which are easy to polymerize free-radically, such as, for example, ethylene, vinylaromatic monomers, such as styrene, α-methylstyrene, o-chlorostyrene or vinyltoluenes, vinyl halides, such as vinyl chloride or vinylidene chloride, esters of vinyl alcohol and monocarboxylic acids containing 1 to 18 carbon atoms, such as vinyl acetate, vinyl propionate, vinyl-n-butyrate, vinyl laurate, and vinyl stearate, esters of α,β-mono-ethylenically unsaturated monocarboxylic and dicarboxylic acids containing preferably 3 to 6 carbon atoms, such as particularly acrylic acid, methacrylic acid, maleic acid, fumaric acid, and itaconic acid, with alkanols containing generally 1 to 20, preferably 1 to 8, and in particular 1 to 4 carbon atoms, such as, in particular, methyl, ethyl, n-butyl, isobutyl, pentyl, hexyl, heptyl, octyl, nonyl, decyl, 2-ethylhexyl or stearyl acrylate and methacrylate, dimethyl or di-n-butyl fumarate or maleate, nitriles of α,β-mono-ethylenically unsaturated carboxylic acids, such as acrylonitrile, methacrylonitrile, fumaronitrile and maleonitrile, and C₄₋₈ conjugated dienes, such as 1,3-butadiene and isoprene. Said monomers generally constitute the principal monomers, which, based on the total monomer amount, account for a proportion of more than 50%, preferably more than 80%, by weight. As a general rule these monomers are of only moderate to poor solubility in water under standard conditions [20° C., 1 atm=1.01 bar (absolute)].

Monomers which exhibit increased water-solubility under the aforementioned conditions are those which comprise either at least one acid group and/or its corresponding anion or at least one amino, amido, ureido or N-heterocyclic group and/or ammonium derivatives thereof which are alkylated or protonated on the nitrogen. Mention may be made by way of example of α,β-monoethylenically unsaturated monocarboxylic and dicarboxylic acids and their amides, such as acrylic acid, methacrylic acid, maleic acid, fumaric acid, itaconic acid, acrylamide, and methacrylamide, and also vinylsulfonic acid, 2-acrylamido-2-methylpropanesulfonic acid, styrenesulfonic acid, and their water-soluble salts, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate. Normally the aforementioned monomers are used merely as modifying monomers in amounts, based on the total monomer amount, of less than 10%, preferably less than 5%, by weight.

Monomers which customarily enhance the internal strengths of the films formed from the polymer matrix normally contain at least one epoxy, hydroxy, N-methylol or carbonyl group, or at least two nonconjugated ethylenically unsaturated double bonds. Examples of such are monomers containing two vinyl radicals, monomers containing two vinylidene radicals, and monomers containing two alkenyl radicals. Particularly advantageous in this context are the diesters of dihydric alcohols with α,β-monoethylenically unsaturated monocarboxylic acids, among which acrylic and methacrylic acid are preferred. Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular significance in this context are the C₁-C₈ hydroxyalkyl esters of acrylic and methacrylic acid, such as n-hydroxyethyl, n-hydroxypropyl or n-hydroxybutyl acrylate and methacrylate, and also compounds such as diacetoneacrylamide and acetylacetoxyethyl acrylate and methacrylate. Frequently the aforementioned monomers are used in amounts of up to 10% by weight, but preferably less than 5% by weight, based in each case on the total monomer amount.

Monomer mixtures which can be used with particular advantage in accordance with the invention are those which comprise
50% to 99.9% by weight of esters of acrylic and/or methacrylic acid with alkanols containing 1 to 20 carbon atoms, or
50% to 99.9% by weight of styrene and/or butadiene, or
50% to 99.9% by weight of vinyl chloride and/or vinylidene chloride, or
40% to 99.9% by weight of vinyl acetate, vinyl propionate, vinyl esters of Versatic acid and/or vinyl esters of long-chain fatty acids.

In particular it is possible in accordance with the invention to use monomer mixtures of a sort which comprise
0.1% to 5% by weight of at least one α,β-monoethylenically unsaturated monocarboxylic or dicarboxylic acid containing 3 to 6 carbon atoms and/or its amide and
50% to 99.9% by weight of at least one ester of acrylic and/or methacrylic acid with alkanols containing 1 to 20 carbon atoms, or
0.1% to 5% by weight of at least one α,β-monoethylenically unsaturated monocarboxylic or dicarboxylic acid containing 3 to 6 carbon atoms and/or its amide and
50% to 99.9% by weight of styrene and/or butadiene, or
0.1% to 5% by weight of at least one α,β-monoethylenically unsaturated monocarboxylic or dicarboxylic acid containing 3 to 6 carbon atoms and/or its amide and
50% to 99.9% by weight of vinyl chloride and/or vinylidene chloride, or
0.1% to 5% by weight of at least one α,β-monoethylenically unsaturated monocarboxylic or dicarboxylic acid containing 3 to 6 carbon atoms and/or its amide and
40% to 99.9% by weight of vinyl acetate, vinyl propionate, vinyl esters of Versatic acid and/or vinyl esters of long-chain fatty acids.

Correspondingly, as a result of the free-radical polymerization, polymers are obtained which are constructed from aforementioned monomers in copolymerized form.

It may also be observed at this point that in the context of this specification the term “ethylenically unsaturated monomer” is also intended to comprise mixtures of ethylenically unsaturated monomers, and the term “polymer” is also intended to comprise copolymers.

The total amount of ethylenically unsaturated monomers in the aqueous crude emulsion is generally ≧30% and ≦90%, frequently ≧40% and ≦85%, and often ≧50% and ≦80% by weight.

The dispersing assistants used according to the process of the invention may in principle be emulsifiers and/or protective colloids.

Examples of suitable protective colloids are polyvinyl alcohols, polyalkylene glycols, alkali metal salts of polyacrylic acids and polymethacrylic acids, gelatin derivatives, or acrylic acid, methacrylic acid, maleic anhydride, 2-acrylamido-2-methylpropanesulfonic acid and/or 4-styrenesulfonic acid copolymers and their alkali metal salts, or else N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-bearing acrylates, methacrylates, acrylamides and/or methacrylamides homopolymers and copolymers. A detailed description of further suitable protective colloids is found in Houben-Weyl, Methoden der organischen Chemie, Volume XIV/1, Makromolekulare Stoffe [macromolecular compounds], Georg-Thieme-Verlag, Stuttgart, 1961, pp. 411 to 420.

It is of course also possible to use mixtures of protective colloids and/or emulsifiers. As dispersing assistants it is common to use exclusively emulsifiers, whose relative molecular weights, unlike those of the protective colloids, are usually below 1000. They may be anionic, cationic or nonionic in nature. Where mixtures of surface-active substances are used it will be appreciated that the individual components must be compatible with one another, something which in case of doubt can be ascertained by means of a few preliminary tests. Generally speaking, anionic emulsifiers are compatible with one another and with nonionic emulsifiers. The same is true of cationic emulsifiers, whereas anionic and cationic emulsifiers are usually not compatible with one another. An overview of suitable emulsifiers is found in Houben-Weyl, Methoden der organischen Chemie, Volume XIV/1, Makromolekulare Stoffe [macromolecular compounds], Georg-Thieme-Verlag, Stuttgart, 1961, pp. 192 to 208.

In accordance with the invention, however, emulsifiers in particular are used as dispersing assistants.

Examples of customary nonionic emulsifiers are ethoxylated mono-, di-, and trialkylphenols (EO degree: 3 to 50, alkyl radical: C₄ to C₁₂) and also ethoxylated fatty alcohols (EO degree: 3 to 80; alkyl radical: C₈ to C₃₆). Examples thereof are the Lutensol® A grades (C₁₂C₁₄ fatty alcohol ethoxylates, EO degree: 3 to 8), Lutensol® AO grades (C₁₃C₁₅ oxo alcohol ethoxylates, EO degree: 3 to 30), Lutensole® AT grades (C₁₆C₁₈ fatty alcohol ethoxylates, EO degree: 11 to 80), Lutensole® ON grades (C₁₀ oxo alcohol ethoxylates, EO degree: 3 to 11) and the Lutensol® TO grades (C₁₃ oxo alcohol ethoxylates, EO degree: 3 to 20) from BASF AG.

Customary anionic emulsifiers are, for example, alkali metal salts and ammonium salts of alkyl sulfates (alkyl radical: C₈ to C₁₂), of sulfuric monoesters with ethoxylated alkanols (EO degree: 4 to 30, alkyl radical: C₁₂ to C₁₈) and with ethoxylated alkyl phenols (EO degree: 3 to 50, alkyl radical: C₄ to C₁₂), of alkylsulfonic acids (alkyl radical: C₁₂ to C₁₈), and of alkylarylsulfonic acids (alkyl radical: C₉ to C₁₈).

Compounds which have proven to be further anionic emulsifiers are, in addition, compounds of the general formula (I)

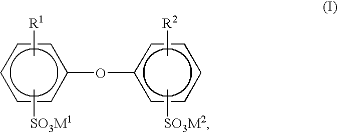

in which R¹ and R² are hydrogen atoms or C₄ to C₂₄ alkyl and are not simultaneously hydrogen atoms, and M¹ and M² can be alkali metal ions and/or ammonium ions. In the general formula (I) R¹ and R² are preferably linear or branched alkyl radicals having 6 to 18 carbon atoms, in particular having 6, 12, and 16 carbon atoms, or hydrogen, R¹ and R² not both simultaneously being hydrogen atoms. M¹ and M² are preferably sodium, potassium or ammonium, sodium being particularly preferred. Particularly advantageous compounds (I) are those in which M¹ and M² are sodium, R¹ is a branched alkyl radical having 12 carbon atoms, and R² is a hydrogen atom or R¹. Use is frequently made of technical mixtures which include a fraction of 50% to 90% by weight of the monoalkylated product, such as Dowfax® 2A1, for example (brand of the Dow Chemical Company). The compounds (I) are general knowledge, from U.S. Pat. No. 4,269,749 for example, and are available commercially.

Suitable cation-active emulsifiers are generally primary, secondary, tertiary or quaternary ammonium salts containing a C₆ to C₁₈ alkyl, alkylaryl or heterocyclic radical, alkanolammonium salts, pyridinium salts, imidazolinium salts, oxazolinium salts, morpholinium salts, thiazolinium salts, and salts of amine oxides, quinolinium salts, isoquinolinium salts, tropylium salts, sulfonium salts and phosphonium salts. Mention may be made by way of example of dodecylammonium acetate or the corresponding sulfate, the sulfates or acetates of the various 2-(N,N,N-trimethylammonio)ethylparaffinic esters, N-cetylpyridinium sulfate, N-laurylpyridinium sulfate, and N-cetyl-N,N,N-trimethylammonium sulfate, N-dodecyl-N,N,N-trimethylammonium sulfate, N-octyl-N,N,N-trimethylammonium sulfate, N,N-distearyl-N,N-dimethylammonium sulfate, and the gemini surfactant N,N′-(lauryldimethyl)ethylenediamine disulfate, ethoxylated tallowalkyl-N-methylammonium sulfate, and ethoxylated oleylamine (for example, Uniperol® AC from BASF AG, approximately 12 ethylene oxide units). Numerous further examples are found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989. It is advantageous if the nucleophilicity of the anionic counter-groups is as low as possible, such as perchlorate, sulfate, phosphate, nitrate and carboxylates, such as acetate, trifluoroacetate, trichloroacetate, propionate, oxalate, citrate or benzoate, for example, and also conjugated anions of organosulfonic acids, such as methylsulfonate, trifluoromethylsulfonate, and para-toluenesulfonate, for example, and additionally tetrafluoroborate, tetraphenylborate, tetrakis(pentafluorophenyl)borate, tetrakis[bis(3,5-trifluoromethyl)phenyl]borate, Hexafluorophosphate, Hexafluoroarsenate or hexafluoroantimonate.

The emulsifiers used with preference as dispersing assistants are employed advantageously in a total amount of 0.005% to 20%, preferably 0.01% to 15%, in particular 0.1% to 10% by weight, based in each case on the total monomer amount.

The total amount of the protective colloids used as dispersing assistants in addition to or instead of the emulsifiers is often 0.1% to 10% and frequently 0.2% to 7% by weight, based in each case on the total monomer amount.

Preference is nevertheless given to using anionic and/or nonionic emulsifiers as dispersing assistants.

In accordance with the invention, preference is given to ethylenically unsaturated monomers or mixtures of ethylenically unsaturated monomers which have a low water solubility. By low water solubility in the context of this specification is meant that the ethylenically unsaturated monomer or the mixture of ethylenically unsaturated monomers or the organic solvent has a solubility in deionized water at 20° C. and 1 atm (absolute) of ≦50 g/l, preferably ≦10 g/l, and advantageously ≦5 g/l or ≦1 g/l.

Low-water-solubility organic solvents suitable for the process of the invention are, for example, liquid aliphatic and aromatic hydrocarbons having 5 to 30 carbon atoms, such as n-pentane and isomers, cyclopentane, n-hexane and isomers, cyclohexane, n-heptane and isomers, n-octane and isomers, n-nonane and isomers, n-decane and isomers, n-dodecane and isomers, n-tetradecane and isomers, n-hexadecane and isomers, n-octadecane and isomers benzene, toluene, ethylbenzene, cumene, o-, m- or p-xylene, mesitylene, and, generally, hydrocarbon mixtures in the boiling range from 30 to 250° C. can be employed. Likewise suitable for use are hydroxy compounds, such as saturated and unsaturated fatty alcohols having 10 to 28 carbon atoms, examples being n-dodecanol, n-tetradecanol, n-hexadecanol and the isomers thereof, or cetyl alcohol, esters, such as fatty acid esters having 10 to 28 carbon atoms in the acid moiety and 1 to 10 carbon atoms in the alcohol moiety, for example, or esters of carboxylic acids and fatty alcohols having 1 to 10 carbon atoms in the carboxylic acid moiety and 10 to 28 carbon atoms in the alcohol moiety. It is of course also possible to use mixtures of aforementioned solvents. For preparing the crude emulsion it is advantageous to use a low-water-solubility organic solvent.

The total amount of low-water-solubility organic solvent, used if appropriate, is generally up to 10%, frequently ≧0.01 and ≦5%, and often ≧0.1% and ≦2% by weight, based in each case on the total monomer amount.

It is advantageous if the ethylenically unsaturated monomers and the organic solvent used if appropriate, and their amounts, are chosen such that the solubility of the ethylenically unsaturated monomers and of the organic solvent used if appropriate in the aqueous medium of the crude emulsion is advantageously a solubility ≦50% or ≦40% by weight, preferably ≦30% and ≦20% by weight, and with particular preference ≦10% by weight, based in each case on the total amount of the ethylenically unsaturated monomers and of the organic solvent used if appropriate for preparing the crude emulsion, and such that they are therefore present in the form of a separate phase in the aqueous medium.

Besides the ethylenically unsaturated monomers, dispersing assistants, and water, particularly deionized water, it is possible optionally for further auxiliaries to be used for preparing the crude emulsion, such as, for example, free-radical chain regulators, foam inhibitors, complexing agents or biocidal compounds. The amounts of these optionally employed auxiliaries is in each case ≦5% by weight, based in each case on the aqueous crude emulsion.

By means of simple mixing, with the use for example of customary stirrers, nozzles, static and/or dynamic mixing means, the crude emulsion is prepared from the ethylenically unsaturated monomers, dispersing assistants, water, and the organic solvents and other auxiliaries, used if appropriate, with an average droplet diameter ≧2 μm.

The average size of the droplets of the dispersed phase of the aqueous crude emulsion and of the aqueous miniemulsion is determined in accordance with the principle of quasielastic dynamic light scattering (the so-called z-average droplet diameter d_{z} of the unimodal analysis of the autocorrelation function). In the examples of this specification this was carried out using a Coulter N4 Plus Particle Analyser from Coulter Scientific Instruments (1 atm, 25° C.). The measurements were performed on dilute aqueous emulsions. To this end, between 0.1 and 1 g of the aqueous crude emulsion/mini-emulsion was diluted with 1000 g of water, which had been saturated beforehand with the ethylenically unsaturated monomers comprised in the aqueous crude emulsion/miniemulsion, and to which thereafter 5% by weight of the dispersant used was added. The purpose of this measure is to prevent dilution being accompanied by a change in droplet diameter.

Advantageously the crude emulsion is prepared from the major amounts, i.e., >50% by weight, especially ≧80% by weight or ≧90% by weight, of water, dispersing assistant, ethylenically unsaturated monomers, and, if appropriate, low-water-solubility organic solvent.

Essential to the process is that the crude emulsion thus obtained is passed, for the purpose of forming the monomer miniemulsion, through at least one microporous membrane having an average pore diameter≦1000 nm.

The microporous membranes having an average pore diameter≦1000 nm can be conventional ultrafiltration and microfiltration membranes.

With advantage the mechanical stability of the microporous membrane is based on a coarse-pored first layer (substructure). It is self-supporting and pressure-stable without need of any support means. It serves as a support for one or more microporous membranes having an average pore diameter≦1000 nm. Each of the microporous membranes having an average pore diameter≦1000 nm are generally thinner than the substructure.

Applied preferably on the first coarse-pored layer are at least two microporous membranes disposed in series and having an average pore diameter≦1000 nm, whose average pore diameter decreases with increasing distance from the first layer.

It is advantageous if the crude emulsion is passed first through the coarse-pored first layer and subsequently through the microporous membrane(s) disposed thereon and having an average pore diameter≦1000 nm. Clogging of the microporous membrane(s) is largely prevented by an asymmetric construction of this kind.

The pore diameter of the coarse-pored first layer is situated advantageously in the range between 1 and 20 μm and its thickness in the range from 0.1 to 10 mm.

A particularly suitable substructure pore diameter is situated within the same order of magnitude as the droplet diameter of the disperse phase of the crude emulsion, i.e., in the range ≧2 μm.

The pore diameter of the microporous membrane, which is in a direct relationship to the achieved droplet diameter of the monomer miniemulsion and its droplet size distribution, is preferably in a range ≧10 and ≦1000 nm, especially ≦900 nm, ≦700 nm or ≦500 nm and ≧50 nm, ≧100 nm or ≧150 nm. Advantageously the average pore diameter is in the range ≧50 and ≦800 nm or ≧70 and ≦600 nm. The average pore diameter of a microporous membrane is generally determined by means of a Coulter porometer in accordance with ASTM E 1294 using isopropanol as wetting agent. In addition, suitable microporous membranes have a porosity to DIN ISO 30911-3 of 1% to 70%. The thickness of a microporous membrane is advantageously in the range between 1 and 200 μm.

It is of advantage in accordance with the invention if the average pore diameter of the first micorporous membrane in contact with the crude emulsion is greater than or equal to the average pore diameter of the second and any further microporous membrane. It is particularly advantageous if the average pore diameter of the first microporous membrane in contact with the crude emulsion is greater than the average pore diameter of the second and any further microporous membrane. It is advantageous if the average pore diameter of any further microporous membrane decreases further with increasing distance from the first microporous membrane.

Depending on the emulsification task it is possible to use the microporous membrane in any of a very wide variety of geometries and sizes. Possible by way of example are flat geometries, tube geometries, and multichannel geometries with two or more tube geometries integrated in one unit, and also capillary geometries or wound geometries. With particular preference the microporous membrane has a tubular geometry with an internal or external coarse-pored first layer, or a planar geometry. Preference is given here to pressure-stable, self-supporting membrane structures which without additional support elements ensure sufficient pressure stability even in cases of high transmembrane pressure difference and high throughputs on the industrial scale.

The microporous membranes may be composed of organic polymers, ceramic, metal, carbon or combinations thereof. In accordance with the invention they are chosen such that they are stable with respect to the aqueous crude emulsion under the conditions of its passage (pressure, temperature).

Particularly preferred microporous membranes are those constructed from hydrophilic materials, such as, for example, from metal, ceramic, regenerated cellulose, acrylonitrile, hydrophilicized acrylonitrile, hydrophilicized polysulfone or hydrophilicized polyether sulfone and/or hydrophilicized polyether ether ketone (in this regard see, for example, “Ullmann's Encyclopedia of Industrial Chemistry”, 6th edition [electronic]). Particular preference is given to using at least one microporous metal membrane. One measure of the hydrophilicity of a material is the contact angle of a drop of deionized water on a horizontal, smooth, and clean surface, particularly a grease-free surface, of said material. For the purposes of this specification, hydrophilic materials are those which have a contact angle <900, ≦80° or ≦70°.

The microporous membranes can be produced for example by sintering the corresponding powder materials, stretching the corresponding polymer films, exposing the polymer films to high-energy electromagnetic radiation, by means of etching operations, and by phase inversion of homogeneous polymer solutions or polymer melts.

Also it is possible for the microporous membrane to be of symmetrical or integrally asymmetrical construction. By integrally asymmetrical microporous membranes are meant those whose average pore diameter enlarges from one side to the other side within the microporous membrane layer by a factor of 3 to 1000.

The temperatures for the passage of the invention through the microporous membrane(s) are not restricted in principle. Frequently they are in the range ≧0 and ≦150° C., in particular in the range ≧10 and ≦80° C., and often in the range ≧20 and ≦60° C.

The pressure to be applied to pass the aqueous crude emulsion through the porous membrane(s) is generated in particular by means of a pump, by gas pressure or by hydrostatic head. The transmembrane pressure difference between aqueous crude emulsion and aqueous miniemulsion, which exerts an influence on the average droplet diameter and the droplet size distribution, is between 0.1 and 1000 bar, preferably between 0.5 and 100 bar, more preferably between 1 and 50 bar.

The at least one microporous membrane is therefore conventionally disposed in a corresponding pressure housing with a separation of crude emulsion side and miniemulsion side.

Advantageously the at least one microporous membrane is disposed in the feedline to the polymerization vessel. With particular advantage the at least one microporous membrane is located as close as is technically possible to the inlet aperture of the feedline to the polymerization vessel. With advantage the inlet aperture is located in the bottom third, particularly in the base, of the polymerization vessel.

The process of the invention involves the preparation of an aqueous crude emulsion having an average droplet diameter≧2 μm, comprising at least portions of water, dispersing assistant, ethylenically unsaturated monomer, and, if appropriate, low-water-solubility organic solvent. The aqueous crude emulsion here advantageously comprises the major amounts or total amounts of dispersing assistant, ethylenically unsaturated monomer, and, if appropriate, low-water-solubility organic solvent. The aqueous crude emulsion can be prepared by mixing of its individual components in a stirred tank or by means of customary dynamic and/or static mixing means. With particular advantage the individual components of the aqueous crude emulsion are metered into the feedline to the polymerization vessel, where they are mixed in the flow direction to the polymerization vessel by means of dynamic and/or static mixing means to form the aqueous crude emulsion, which immediately thereafter is passed through the at least one microporous membrane, for the purpose of forming a miniemulsion, and thereafter directly into the polymerization vessel.

The implementation of the free-radically induced polymerization in aqueous medium takes place in principle in accordance with the method of free-radically initiated aqueous emulsion polymerization. This method has been the subject of numerous prior description and is therefore sufficiently well known to the skilled worker [cf., e.g., Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2nd Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Höischer, Dispersionen synthetischer Hochpolymerer, pages 1 to 160, Springer-Verlag, Berlin, 1969 and patent DE-A 40 03 422]. The free-radically initiated aqueous emulsion polymerization normally takes place by the disperse distribution of the ethylenically unsatured monomers in the aqueous medium, generally with the additional use of dispersing assistants, and the polymerization of the resulting dispersion by means of at least one free-radical polymerization initiator. Frequently, with regard to the aqueous polymer dispersions obtained, the residual amounts of unreacted monomers are lowered by means of chemical and/or physical methods which are likewise known to the skilled worker [see, for example, EP-A 771328, DE-A 19624299, DE-A 19621027, DE-A 19741184, DE-A 19741187, DE-A 19805122, DE-A 19828183, DE-A 19839199, DE-A 19840586, and 19847115]; the polymer solids content is adjusted to a desired value by means of dilution or concentration, or further customary additives, such as bactericidal or foam-suppressing additives, for example, are added to the aqueous polymer dispersion. The present process differs from the method of free-radically initiated aqueous emulsion polymerization essentially in that the miniemulsion used for the polymerization has been obtained by passage of an aqueous crude emulsion through a microporous membrane having an average pore diameter≦1000 nm.

Depending on the polymerization process carried out, portions of water, dispersing assistant, ethylenically unsaturated monomers, and low-water-solubility solvent can be charged to the polymerization vessel, heated to polymerization temperature, and the polymerization initiated by addition of the free-radical initiator. Advantageously in this case the remaining amounts of dispersing assistant, ethylenically unsaturated monomers, and low-water-solubility solvent, and also the major amount of water, are first mixed to the aqueous crude emulsion via dynamic and/or static mixing means disposed in the feedline in the direction of flow to the polymerization vessel, and immediately after this said crude emulsion is passed through the at least one microporous membrane, for the purpose of forming a miniemulsion, and directly thereafter into the polymerization vessel. In this context it can be advantageous if the monomer miniemulsion is fed to the polymerization vessel in accordance with the rate of monomer conversion in the polymerization vessel. With particular advantage the metering of the miniemulsion into the polymerization vessel under polymerization conditions takes place such that, following onset of the polymerization reaction, and after a total of 10% by weight of the total amount of ethylenically unsaturated monomers used for the polymerization have been reacted by polymerization, at each point in time ≦10%, preferably ≦5%, and with particular preference ≦1% by weight of the amount of ethylenically unsaturated monomers metered into the polymerization vessel up to the particular point in time are present in free form, i.e., in unpolymerized form, something which can be ascertained by means of reaction-calorimetry measurements.

It will be appreciated that for preparing the aqueous polymer dispersions it is also possible to use polymer seed latices, which can be included in the initial charge to the polymerization vessel before the free-radical polymerization reaction is begun or can be metered in during the polymerization reaction. With advantage the total amount of the polymer seed is charged to the polymerization vessel before the free-radical polymerization reaction is begun.

Characteristic of the process of the invention is that for triggering the free-radically induced polymerization reaction it is possible to use not only water-soluble but also oil-soluble free-radical initiators. By water-soluble free-radical initiators are meant in general all those free-radical initiators which are normally employed in the context of free-radically aqueous emulsion polymerization, whereas oil-soluble free-radical initiators are all those free-radical initiators which the skilled worker conventionally employs in the context of free-radically initiated solution polymerization. For the purposes of this specification, water-soluble free-radial initiators shall comprehend all those free-radical initiators which at 20° C. and atmospheric pressure (1 atm) in deionized water have a solubility ≧5% by weight, whereas oil-soluble free-radical initiators shall comprehend all those free-radical initiators which under aforementioned conditions have a solubility ≦5% by weight. Water-soluble free-radical initiators frequently have a water solubility under aforementioned conditions ≧8%, ≧10%, or ≧15% by weight, whereas oil-soluble free-radical initiators frequently have a water solubility ≦4%, ≦3%, ≦2% or ≦1% by weight.

The water-soluble free-radical initiators here may be, for example, peroxides and also azo compounds. As will be appreciated, redox initiator systems as well are suitable. Peroxides which can be used include, in principle, inorganic peroxides, such as hydrogen peroxide or peroxodisulfates, such as the mono- or di-alkali metal or ammonium salts of peroxodisulfuric acid, such as, for example, its mono- and di-sodium, -potassium or ammonium salts, or organic peroxides, such as alkyl hydroperoxides, examples being tert-butyl, p-menthyl or cumyl hydroperoxide. Finding use substantially as azo compound are 2,2′-azobis(isobutyronitrile), 2,2′-azobis(2,4-dimethylvaleronitrile) and 2,2′-azobis(amidinopropyl)dihydrochloride (AIBA, corresponding to V-50 from Wako Chemicals). Suitable oxidants for redox initiator systems include essentially the abovementioned peroxides. As corresponding reductants it is possible to use sulfur compounds with a low oxidation state, such as alkali metal sulfites, examples being potassium and/or sodium sulfite, alkali metal hydrogen sulfites, examples being potassium and/or sodium hydrogen sulfite, alkali metal metabisulfites, examples being potassum and/or sodium metabisulfite, formaldehyde-sulfoxylates, examples being potassium and/or sodium formaldehyde-sulfoxylate, alkali metal salts, especially potassium and/or sodium salts, aliphatic sulfinic acids, and alkali metal hydrogen sulfides, such as potassium and/or sodium hydrogen sulfide, for example, salts of polyvalent metals, such as iron(II) sulfate, iron(II) ammonium sulfate, iron(II) phosphate, endiols, such as dihydroxymaleic acid, benzoin and/or ascorbic acid, and reducing saccharides, such as sorbose, glucose, fructose and/or dihydroxyacetone.

Preferred water-soluble free-radial initiators used are a mono- or di-alkali metal or ammonium salt of peroxodisulfuric acid: for example, dipotassium peroxydisulfate, disodium peroxydisulfate or diammonium peroxydisulfate. It is of course also possible to use mixtures of aforementioned water-soluble free-radical initiators.

As oil-soluble free-radical initiators mention may be made, by way of example, of dialkyl and diaryl peroxides, such as di-tert-amyl peroxide, dicumyl peroxide, bis(tert-butylperoxyisopropyl)benzene, 2,5-bis(tert-butylperoxy)-2,5-dimethylhexane, tert-butyl cumene peroxide, 2,5-bis(tert-butylperoxy)-2,5-dimethyl-3-hexene, 1,1-bis(tert-butylperoxy)-3,3,5-trimethylcyclohexane, 1,1-bis(tert-butylperoxy)cyclohexane, 2,2-bis(tert-butylperoxy)butane or di-tert-butyl peroxide, aliphatic and aromatic peroxy esters, such as cumyl peroxyneodecanoate, 2,4,4-trimethylpentyl 2-peroxyneodecanoate, tert-amyl peroxyneodecanoate, tert-butyl peroxyneodecanoate, tert-amyl peroxypivalate, tert-butyl peroxypivalate, tert-amyl peroxy-2-ethylhexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl and dibenzoyl peroxides, such as diisobutanoyl peroxide, bis(3,5,5-trimethylhexanoyl) peroxide, dilauroyl peroxide, didecanoyl peroxide, 2,5-bis(2-ethylhexanoylperoxy)-2,5-dimethylhexane or dibenzoyl peroxide, and also peroxycarbonates, such as bis(4-tert-butylcyclohexyl) peroxydicarbonate, bis(2-ethylhexyl) peroxydicarbonate, di-tert-butyl peroxydicarbonate, dicetyl peroxydicarbonate, dimyristyl peroxydicarbonate, tert-butyl peroxyisopropyl carbonate or tert-butyl peroxy-2-ethylhexyl carbonate.

As oil-soluble free-radical initiator it is preferred to use a compound selected from the group comprising tert-butyl peroxy-2-ethylhexanoate (Trigonox® 21), tert-amylperoxy-2-ethylhexanoate, tert-butyl peroxybenzoate (Trigonox® C), tert-amyl peroxybenzoate, tert-butyl peroxyacetate, tert-butyl peroxy-3,5,5-trimethylhexanoate (Trigonox® 42 S), tert-butyl peroxyisobutanoate, tert-butyl peroxydiethylacetate, tert-butyl peroxypivalate, tert-butyl peroxyisopropyl carbonate, (Trigonox® BPIC) and tert-butyl peroxy-2-ethylhexyl carbonate (Trigonox® 117). It is of course also possible to use mixtures of aforementioned oil-soluble free-radial initiators.

Particular preference, however, is given to using water-soluble free-radical initiators in the form of an aqueous solution.

The total amount of free-radical initiator used is 0.01% to 5%, frequently 0.1% to 3%, and often 0.5% to 2% by weight, based in each case on the total monomer amount. Depending on the chosen mode of polymerization it is possible to include the total amount or only a portion of the free-radical initiator used in the initial charge to the polymerization vessel. Following onset of the polymerization reaction, any remainder is then added to the polymerization vessel, frequently by way of a separate feed, discontinuously in one or more batches, or, advantageously, continuously, with a volume flow which remains the same or which changes.

A suitable reaction temperature for the free-radical polymerization reaction includes—depending, among other factors, on the free-radical initiator employed—the entire range from 0 to 170° C. Generally here temperatures of 50 to 120° C. are employed, frequently 60 to 110° C. and often 70 to 100° C. The free-radical polymerization reaction can be carried out under a pressure less than, equal to or greater than 1 atm (absolute), in which case the polymerization temperature may exceed 100° C. and may amount to up to 170° C. It is preferred to polymerize volatile monomers such as ethylene, butadiene or vinyl chloride under increased pressure. In this case the pressure may adopt values of 1.2, 1.5, 2, 5, 10 or 15 bar or even higher. Where polymerization reactions are carried out under subatmospheric pressure, pressures of 950 mbar, frequently of 900 mbar, and often 850 mbar (absolute) are set. With advantage the free-radical polymerization reaction is conducted at atmospheric pressure under an inert gas atmosphere, such as under a nitrogen or argon atmosphere, for example.

The free-radical polymerization reaction takes place in general to an overall monomer conversion of >95%, advantageously ≧97%, and preferably ≧98% by weight.

The polymer particles of the aqueous polymer dispersions obtainable by the process of the invention generally have average particle diameters which are between 10 and 1000 nm, frequently between 50 and 700 nm, and often between 100 and 500 nm. For the purposes of this specification the average particle sizes and particle size distribution were determined by the method of hydrodynamic fractionation. A PSDA particle size distribution analyser was used from Polymer Laboratories Ltd., United Kingdom, with a No. 2 cartridge at a measurement temperature of 23° C. The measurement time was 480 seconds; a UV detector was used at 254 nm. The parameter reported is in each case the arithmetic mean of the volume diameter.

It is of course possible for the organic solvent used if appropriate to be separated from the aqueous polymer dispersion by customary methods, such as by stripping with nitrogen or steam or by applying reduced pressure, for example.

The present process opens up easy access to aqueous monomer emulsions having an average droplet diameter≦1000 nm and to their use in the preparation of stable aqueous polymer dispersions. The aqueous polymer dispersions obtainable with the process of the invention also generally comprise less coagulum than the aqueous polymer dispersions obtainable by conventional methods of aqueous emulsion polymerization.

### EXAMPLES

The particle size distribution was determined by means of hydrodynamic fractionation. A PSDA particle size distribution analyser was used from Polymer Laboratories Ltd., United Kingdom, with a No. 2 cartridge at a measuring temperature of 23° C. The measuring time was 480 seconds; a UV detector was used at 254 nm. The parameter measured was the arithmetic mean of the volume diameter.

The metal membrane SIKA-R0,1AS was used, with an average pore diameter of 0.35 μm, from GKN Sinter Metals Filters GmbH, Radevormberg, Germany.

The amount of coagulum was determined by filtering the aqueous polymer dispersion through a polyamide fabric having a pore size of 125 μm. For this purpose, the residue was washed with water and then dried at 120° C. for 1 hour.

The solids contents were determined by drying a defined amount (approximately 5 g) of the aqueous polymer dispersion to constant weight in a drying oven at 140° C. Two separate measurements were carried out in each case. The figure reported in the respective examples represents the average value of the two measurement results.

The glass transition temperature was determined by the DSC method using a DSC822 (series TA8000) DSC instrument from Mettler-Toledo, Germany, in accordance with DIN 53765.

All polymerization experiments were carried out in a 3 liter polymerization vessel of glass, with a height to diameter ratio of 2.1, equipped with an anchor stirrer with a stirrer frequency of 150 revolutions per minute.

All aqueous crude emulsions were prepared in a 3 liter emulsifying vessel of glass, with a height to diameter ratio of 2.1, equipped with an anchor stirrer with a stirrer frequency of 150 revolutions per minute.

### Example 1

The crude emulsion was prepared in the emulsifying vessel at 20 to 25° C. (room temperature) under a nitrogen atmosphere. In this case, 1200 g of fully deionized water were introduced as an initial charge, after which 6.6 g of a 15% strength by weight aqueous solution of sodium lauryl sulfate and thereafter a solution consisting of 200 g of styrene, 200 g of stearyl acrylate and 2 g of hexadecane were added. The mixture obtained was stirred for 3 minutes.

Subsequently the crude emulsion obtained was forced with a nitrogen pressure of 3 bar (overpressure) within 10 minutes through the metal membrane SIKA-R0,1AS into the polymerization vessel.

Subsequently the monomer miniemulsion obtained was stirred in the reaction vessel at 150 revolutions per minute under a nitrogen atmosphere and was heated to 85° C. over the course of 20 minutes. Subsequently a solution of 4 g of sodium peroxodisulfate and 200 g of deionized water was metered into the monomer miniemulsion at this temperature over the course of 1 hour, after which the polymerization mixture was stirred for a further 2 hours. Subsequently the aqueous polymer dispersion obtained was cooled to room temperature.

The resultant aqueous polymer dispersion had a solids content of 21.9% by weight. The arithmetic mean of the volume diameter of the resultant polymer particles was 595 nm; the standard deviation of the particle diameter was 204 nm. The glass transition temperature was 69° C.

### Comparative Example 1

Comparative example 1 was carried out as for example 1, with the exception that no microporous membrane was used.

Approximately 30 minutes after the beginning of the metered addition of free-radical initiator, however, the reaction mixture underwent coagulation. A stable aqueous polymer dispersion could not be obtained.

### Example 2

In the polymerization vessel at room temperature and under a nitrogen atmosphere 300 g of deionized water and 83 g of a 33% by weight aqueous polystyrene latex having a weight-average particle diameter D₅₀ of 30 nm were mixed and the mixture was heated to 90° C. with stirring.

Subsequently, via two separate feeds, beginning simultaneously and continuing over the course of 3 hours, feedstream 1 and feedstream 2 were introduced continuously into the polymerization vessel at constant volume flowrates, with the reaction temperature maintained. Over the entire feed time, feedstream 1 was forced into the polymerization vessel through a metal membrane SIKA-R0,1AS by means of a nitrogen overpressure which within the emulsifying vessel was held constant at 2.4 bar.

After the end of feedstreams 1 and 2, the polymerization mixture was stirred further at 90° C. for 30 minutes, then cooled to 85° C., after which, via separate feeds, beginning simultaneously, a solution of 8 g of tert-butyl hydroperoxide and 80 g of deionized water, and a solution consisting of 3.5 g of acetone, 5.7 g of sodium hydrogen sulfite, and 76 g of deionized water, were introduced continuously over the course of 2 hours at constant volume flow rates, with the temperature maintained. Thereafter 22 g of a 25% strength by weight aqueous solution of sodium hydroxide were added to the polymerization mixture over the course of one minute, and the resultant aqueous polymer dispersion was cooled to room temperature.

### Feedstream 1

The stated ingredients were introduced into the emulsifying vessel in the stated order, under a nitrogen atmosphere and with stirring, and were stirred for 10 minutes before the beginning of metering into the polymerization vessel.

| | | |
|---|---|---|
| 490 | g | of deionized water |
| 9.9 | g | of a 45% strength by weight aqueous solution of Dowfax ® |
| | | 2A1 |
| 23.1 | g | of a 15% strength by weight aqueous solution of sodium |
| | | dodecylbenzene-sulfonate |
| 640 | g | of styrene |
| 641 | g | of n-butyl acrylate |
| 41.0 | g | of acrylic acid |
| 10.0 | g | of a 25% strength by weight aqueous solution of sodium |
| | | hydroxide |

Subsequently 2.4 bar nitrogen overpressure was injected and the metered addition was commenced. The monomer emulsion was stirred further throughout metering.

Feedstream 2 consisted of a solution of 13.6 g of sodium peroxodisulfate in 230 g of deionized water.

The solids content of the aqueous polymer dispersion obtained was found to be 51.1% by weight. The arithmetic mean of the volume diameter of the polymer particles was 123 nm and the glass transition temperature was determined as being 22° C. The amount of coagulum >125 μm was 0.9 g.

### Comparative Example 2

Comparative example 2 was carried out in the same way as for example 2, with the exception that no microporous membrane was used.

The solids content of the aqueous polymer dispersion obtained was found to be 51.3% by weight. The arithmetic mean of the volume diameter of the polymer particles was 125 nm and the glass transition temperature was determined as being 22° C. The amount of coagulum >125 μm was 1.5 g.

1. A process for preparing an aqueous polymer dispersion by free-radically initiated polymerization of at least one ethylenically unsaturated monomer in the presence of a dispersing assistant and also if appropriate of a low-water-solubility organic solvent in an aqueous medium, at least a portion of the ethylenically unsaturated monomer and if appropriate of the low-water-solubility organic solvent in the aqueous medium being present in the form of a disperse phase having an average droplet diameter≦1000 nm (miniemulsion), which comprises preparing the miniemulsion by first preparing a crude emulsion having an average droplet diameter≧2 μm, comprising at least portions of water, dispersing assistant, ethylenically unsaturated monomer, and, if appropriate, low-water-solubility organic solvent, and subsequently passing said crude emulsion through at least one microporous membrane having an average pore diameter≦1000 nm.

2. The process according to claim 1, wherein the crude emulsion is prepared from the major amounts of water, dispersing assistant, ethylenically unsaturated monomer, and, if appropriate, low-water-solubility organic solvent.

3. The process according to claim 1, wherein the at least one microporous membrane is disposed in the feedline to the polymerization vessel.

4. The process according to claim 1, wherein at least two microporous membranes disposed in series are used.

5. The process according to claim 4, wherein the average pore diameter of the first microporous membrane in contact with the crude emulsion is greater than or equal to the average pore diameter of the second and any further microporous membrane.

6. The process according to claim 4, wherein the average pore diameter of the first microporous membrane in contact with the crude emulsion is greater than the average pore diameter of the second and any further microporous membrane.

7. The process according to claim 3, wherein the crude emulsion is prepared in the feedline to the polymerization vessel by mixing of its components by means of dynamic and/or static mixing means.

8. The process according to claim 1, wherein at least one microporous metal membrane is used.

9. The process according to claim 1, wherein the average pore diameter of the at least one microporous membrane is ≧50 and ≦800 nm.

10. The process according to claim 1, wherein as ethylenically unsaturated monomer use is made of a monomer mixture comprising
50% to 99.9% by weight of esters of acrylic and/or methacrylic acid with alkanols containing 1 to 20 carbon atoms, or
50% to 99.9% by weight of styrene and/or butadiene, or
50% to 99.9% by weight of vinyl chloride and/or vinylidene chloride, or
40% to 99.9% by weight of vinyl acetate, vinyl propionate, vinyl esters of Versatic acid, vinyl esters of long-chain fatty acids and/or ethylene.
